(19) United States
(12) Patent Application Publication
(10) Pub. No.: US 2005/0123888 A1
(43) Pub. Date: Jun. 9, 2005

(54) Interactive reading system

(76) Inventor: Fu Ching Lee, Los Angeles, CA (US)

Correspondence Address: Fu C. Lee, P.O. Box 6611, Beverly Hills, CA, 90212, US

(21) Appl. No.: 10/730,340

(22) Filed: Dec. 5, 2003

(51) Int. Cl. G09B 5/00

(52) U.S. Cl. 434/317

(57) ABSTRACT

This invention is an interactive reading system comprising a book or other similar printed material and a reading wand. The book can be of varied design and can be manufactured using existing printing methods. The reading wand comprising an electronic circuitry that will decode words on the book and provide audio playback of the associated word.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION-FIELD OF INVENTION

This invention relates to an education aid, particularly to an interactive reading system.

### BACKGROUND OF THE INVENTION

In regards to reading, it has been research that children starts to learn letters and the names of various objects by audible repetition accompanied by visualization of the object. Books, and especially picture books, have always been useful and very instrumental for such a task. Numerous prior art detailed educational aids based on a varied configuration of books, but however good the book is there still requires the presence of an individual that can provide the audible repetition. Some prior art has attempted to solve this problem such as U.S. Pat. No. 6,641,401 B2 to Wood et al, (Nov. 4 2003). Here a device with multiple templates is described. It allows the user to obtain audio playback of words associated with a picture. This was bulky and expensive since each set of templates required a memory module. U.S. Pat. No. RE38286 E to Flowers (Oct. 28 2003) discloses a position location system, which has subsequently been incorporated into systems that can provide audio playback based on user selection. Again, this was bulky and expensive.

Accordingly, several objects and advantages of the present invention are to provide a system that will interactively playback works as directed by a user, the system is to be inexpensive and does not require a bulky based unit for operation.

Still further objects and advantages will become apparent from consideration of the ensuing description and drawings.

### SUMMARY

In accordance with the above-mentioned objects and advantages, the present invention consists of an interactive reading system, the system comprising a book or other similar printed material and a reading wand. The book can be of varied design and can be manufactured using existing printing methods. The reading wand comprising an electronic circuitry that will decode words on the book and provide audio playback of the associated word.

### DRAWINGS-FIGURES

FIG. 1 shows a view of the interactive reading system;

FIG. 2 shows a detailed view of the reading wand;

FIGS. 3a and 3b shows a representation of the printed composition; and

FIG. 4 shows a block diagram representation of the reading wand.

### DETAILED DESCRIPTION

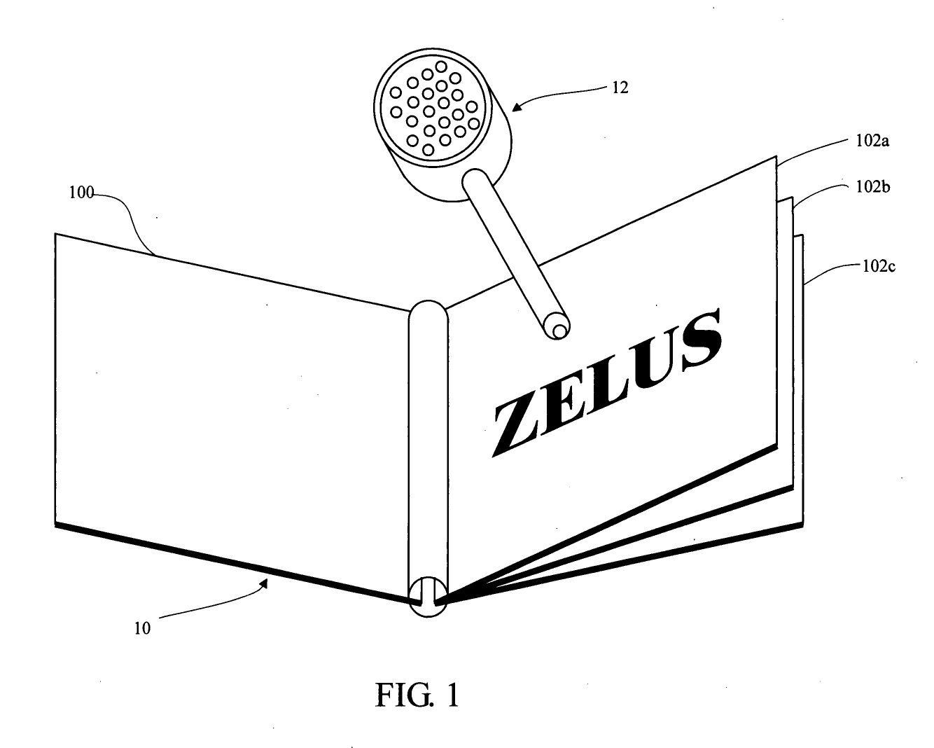

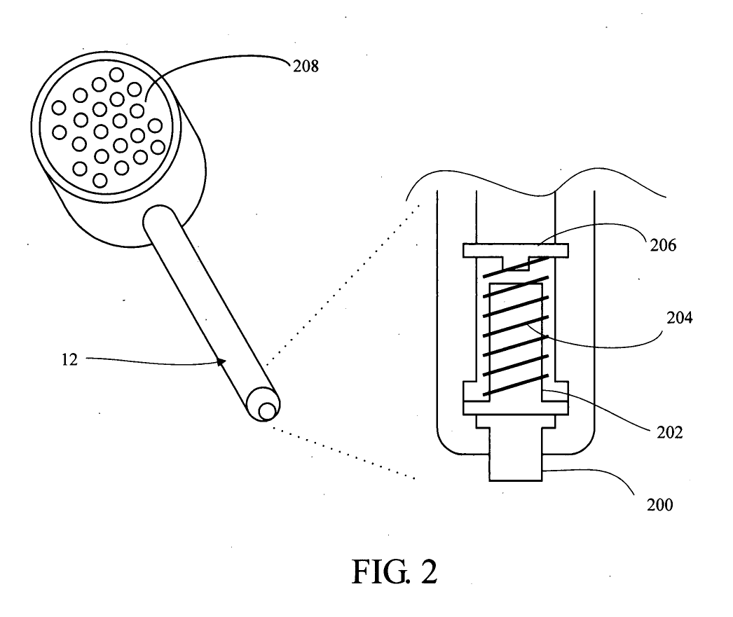

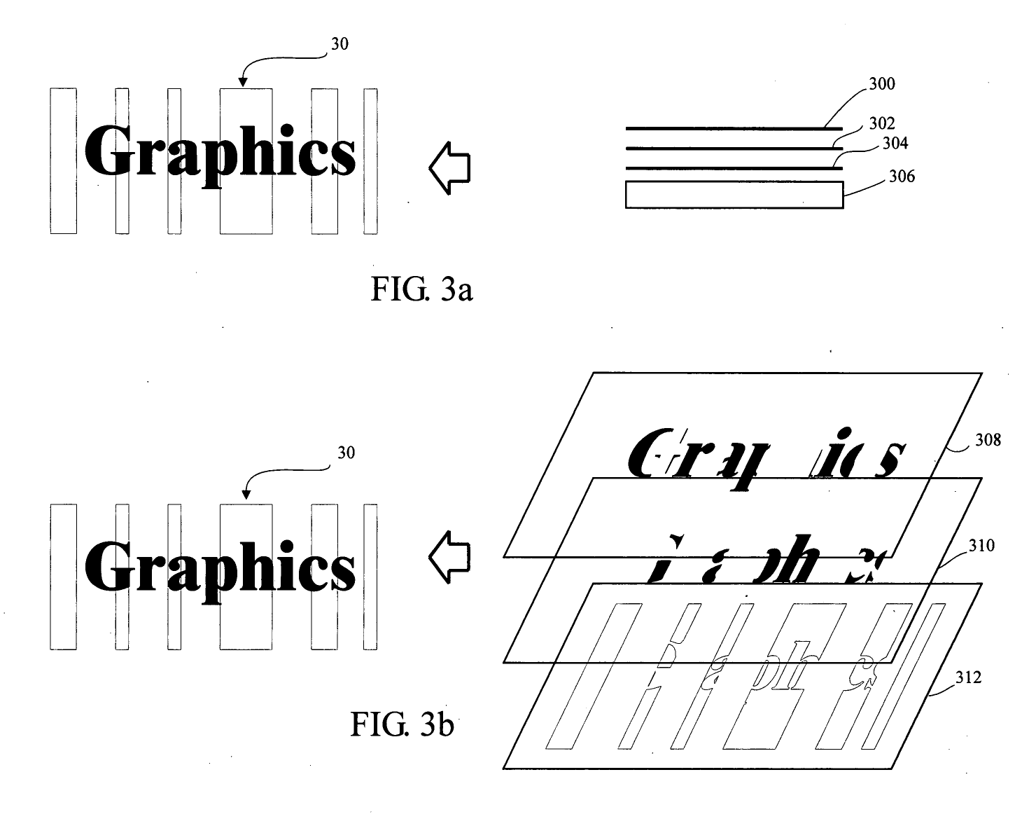

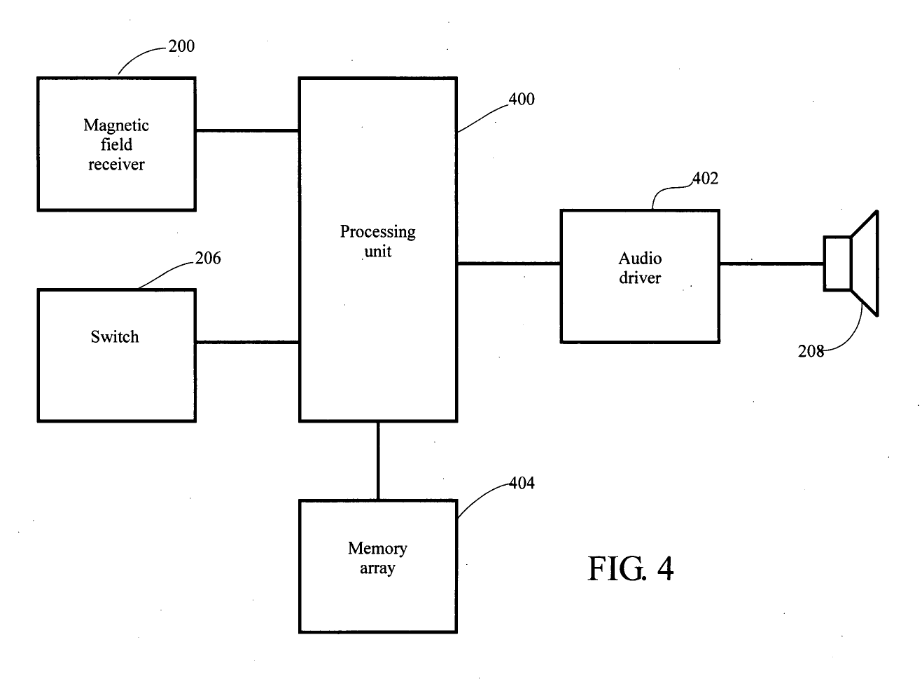

FIG. 1 shows an overview of an interactive reading system in an operational environment. The interactive reading system comprises of a book 10 or other similar printed material and a reading wand 12. The book 10 consists of a front cover 100 and a plurality of printed pages 102a, 102b, 102c . . . . The front cover 100 consists of a sheet of magnet or other similar magnetic material. FIG. 2 shows the reading wand in detail showing the wand's enclosure and the location of the speaker 28. A detail section shows the tip of the reading wand comprising a magnetic field receiver 200, a plunger 202, a spring 204 and a switch 206. FIGS. 3a and 3b shows different preferred embodiments of the printed composition of the book 10. A printed code 30 is shown with a generic printed content. The printed code 30 is constructed to be invisible to the user and consists of linear strips of magnetic ink. In FIG. 3a the composition consist of a paper based 306, a magnetic ink layer 304, a separator layer 302 and a top graphic layer 300. FIG. 3b shows an alternate composition. Here a multiple print process is shown consisting of a plurality of ink layers 308 and a plurality of magnetic ink layers 310, 312. The latter is possible due to manufacturing advances in magnetic ink composition giving rise to varied colored magnetic inks. The printed code 30 is fully contained within the generic printed content. For example a generic printed content could be “DOG” and within this text would be the printed code 30 corresponding to DOG. In this way, the generic printed content provides a visual guide to a user to locate and scan the printed code 30. FIG. 4 shows a block diagram representation of an electronic circuitry of the reading wand comprising a speaker 208 being driven by an audio driver 402. A magnetic field receiver 200 when activated by a switch 206 sends a code to a processing unit 400 where the code is mapped to an audio file stored in a memory array 404.

ASIDE: Magnetic ink character reader—Magnetic ink is a suspension of ferrous magnetic power in a solvent liquid. Magnetic ink is similar in properties to other inks with the added feature that the ferrous magnetic power can retain small magnetic fields i.e. the ink can exhibit a magnetic field. Since is similar to other inks the same printing processes can be used for magnetic inks as for standard inks. Uses for magnetic ink have been documented in many prior art such as U.S. Pat. No. 4,148,010 to Shiau, (Apr. 3 1979). Most of the applications for magnetic ink are related to security or fraud prevention such as used in US paper money system. The use of magnetic ink in this particular application is to provide an invisible code. The code is a simple bar type code consisting of a plurality of vary width magnetic ink interspaced with a plurality of vary width spaces.

The ferrous magnetic powder retains a magnetic field for a period of time and gradually the magnetic field decays until its undetectable. For it to function correctly the ferrous magnetic powder has to be magnetized prior to being sensed.

Operations.

The book 10 in its closed state causes the magnet of the front cover 100 to induce a magnetic field into the magnetic ink layer 304, 310, 312. With the book 100 opened, a user pushes down the reading wand 12 making contact between the magnetic field receiver 200 and the generic printed content. This force causes the plunger 202 to depress and engage the switch 206. Once so engaged the user slides the magnetic field receiver 200 across the generic printed content and hence the printed code 30. Engaging the switch 206 causes the reading wand circuitry to wake up from a low power sleep state. The magnetic field receiver 200 produces an electrical representation of the printed code 30 and conditions this electrical representation to a first digital code. The memory array 404 is pre-programmed with a database of codes, each code with a plurality of associated sound files. The processing unit 400 searches the memory array 404 for a code corresponding to the first digital code. If a match is found the associated sound files are transmitted to the audio driver 402 for conversion into analog signals to drive the speaker 208. If no matches are produced then a generic sound file, for example “Word not recognize, please scan again.”, will be transmitted to the audio driver 402. Once the sound files are completed, the reading wand circuitry will enter a low power sleep state.

Conclusion, Ramifications and Scope of Invention.

Thus, the reader will see that the interactive reading system of the present invention provides a portable yet economical system for locating objects. Furthermore, the apparatus has the additional advantages in that
it is simple and inexpensive to manufacture; and
it does not require a bulky base unit to interact with a user.

While my above description contains much specificity, these should not be construed as limitations on the scope of the invention, but rather as an exemplification of one preferred embodiment thereof. Many other variations are possible such as a second preferred embodiment whereby the book 10 consist of unbound individual pages.

Accordingly, the scope of the invention should be determined not by the embodiment illustrated, but by the appended claims and their legal equivalent.

1. An apparatus for interactive reading, said apparatus comprising of:
a book comprising a plurality of pages, of which at least one page comprising magnetic material, and at least one page comprising printed material, said printed material comprising a plurality of printed ink layers and printed magnetic ink layers, said magnetic ink layers comprising a plurality of magnetic ink patterns organized to form a plurality of printed codes;
a reading wand unit comprising a magnetic field receiver means for converting magnetic fields to a digital code, a storage means for storing data, said data organized in a database form relating codes with sound files, a processing means for searching through the database of codes to match the digital code, an audio driver means for converting sound files to analog signals to drive a speaker.
